(19) United States
(12) Patent Application Publication
(10) Pub. No.: US 2020/0263730 A1
(43) Pub. Date: Aug. 20, 2020

(54) VARIABLE STIFFNESS BUSHING ASSEMBLY

(71) Applicant: HONDA MOTOR CO., LTD., Tokyo (JP)

(72) Inventors: Yuho ITO, Wako-shi (JP); Toshio INOUE, Wako-shi (JP)

(21) Appl. No.: 16/787,717

(22) Filed: Feb. 11, 2020

(30) Foreign Application Priority Data
Feb. 15, 2019 (JP) 2019025090

(51) Int. Cl. F16C 23/04; F16C 27/02

(52) U.S. Cl. CPC F16C 23/04; F16C 27/02

(57) ABSTRACT

A variable stiffness bushing assembly includes: an inner tubular member; an outer tubular member coaxially surrounding the inner tubular member; and an elastic member connected between the inner and outer tubular members. The inner tubular member includes a tubular inner yoke, a coil coaxially wound around the inner yoke, and a pair of outer yokes each attached to the inner yoke at an axially outer end thereof and opposing the other outer yoke at an axially inner end thereof so as to define an annular gap therebetween, and the elastic member internally defines a pair of first liquid chambers which communicate with each other via a first communication passage provided by the annular gap. The first liquid chambers and the first communication passage are filled with a magnetic fluid having a viscosity that changes in dependence on an intensity of a magnetic field applied thereto.

### TECHNICAL FIELD

The present invention relates to an elastic bushing assembly configured to be interposed between a vibration source and a support member that supports the vibration source, and more particularly to a variable stiffness bushing assembly that can change the stiffness thereof.

### BACKGROUND ART

A cushion assembly (variable stiffness bushing assembly) including liquid chambers filled with a magnetic fluid is known. See JPH02-053542U, for instance. According to this prior art, the cushion assembly includes an inner tube, a tubular cushion member surrounding the inner tube, an intermediate tube surrounding the cushion member, and an outer tube surrounding the intermediate tube.

The cushion member internally defines four liquid chambers arranged in the circumferential direction. The outer wall of each liquid chamber is provided with a communication hole. The intermediate tube is provided with an annular bead projecting radially inward in such a manner that an annular passage is defined between the intermediate tube and the outer tube. The intermediate tube is provided with four openings so as to communicate the annular passage with the communication holes of the liquid chambers, respectively.

A coil is received in the annular passage in such a manner the coil wire thereof extends in the circumferential direction. A magnetic field is generated by supplying electric current to the coil, and the viscosity of the magnetic fluid changes in dependence on the intensity of the magnetic field. Thus, the stiffness (the spring property) of the cushion member can be changed by varying the electric current supplied to the coil.

According to this prior art, the variable range of stiffness can be increased by maximizing the intensity of the magnetic field that is applied to the passage of the magnetic fluid. Since the magnetic field is greatest inside the coil, it is conceivable to provide the fluid passage inside the coil. However, it is impractical to place the passage of the magnetic fluid inside the coil. Thus, there is a desire to maximize the intensity of the magnetic field that is applied to the passage of the magnetic fluid without requiring the passage to be provided within the coil.

### SUMMARY OF THE INVENTION

In view of such a recognition and the problems associated with the prior art, a primary object of the present invention is to provide a variable stiffness bushing assembly that can maximize the intensity of the magnetic field that is applied to the passage of the magnetic fluid without requiring the passage to be placed within the coil.

To achieve such an object, one embodiment of the present invention provides a variable stiffness bushing assembly (12, 112, 212), comprising: an inner tubular member (21); an outer tubular member (23) coaxially surrounding the inner tubular member with an annular space defined between the inner tubular member and the outer tubular member; and an elastic member (24) connected between the inner tubular member and the outer tubular member; wherein the inner tubular member includes a tubular inner yoke (25), a coil (26) coaxially wound around the inner yoke, and a pair of outer yokes (27) each attached to the inner yoke at an axially outer end thereof and opposing another outer yoke at an axially inner end thereof so as to define an annular gap therebetween, and the elastic member internally defines a pair of first liquid chambers (38) which are communicated with each other via a first communication passage (45) provided by the annular gap defined between the outer yokes, the first liquid chambers and the first communication passage being filled with a magnetic fluid (50) having a viscosity that changes in dependence on an intensity of a magnetic field applied thereto.

Thereby, a magnetic circuit is formed by the inner yoke and the outer yokes in such a manner that the magnetic field generated by the coil is concentrated in the annular gap. As a result, the stiffness of the variable stiffness bushing assembly can be changed by varying the current flowing through the coil in a highly efficient manner.

Preferably, the first liquid chambers diametrically oppose each other via a central axial line (X) of the inner tubular member.

Thereby, the length of the communicating passage communicating the first liquid chambers to each other can be maximized so that the magnetic field can be applied to the magnetic fluid in a particularly efficient manner.

Preferably, the variable stiffness bushing assembly further comprises an intermediate tubular member (29) made of material having a low magnetic permeability and surrounding the annular gap defined between the axially inner ends of the outer yokes, wherein the intermediate tubular member is provided with a protruding portion (42) that blocks a part of the annular gap defined between the axially inner ends of the outer yokes, and a pair of openings (41) passed radially therethrough in parts thereof adjoining respective circumferential ends of the protruding portion and communicating with the respective first liquid chambers.

Thereby, the protruding portion that blocks a part of the annular gap allows the communication passage between the two first fluid chambers to be exclusively provided as a single arcuate passage. Preferably, the protruding portion extends circumferentially by substantially less than 180 degrees so that a sufficient length of the communication passage may be achieved. As a result, the magnetic field is efficiently applied to the magnetic fluid flowing through the communication passage, and the stiffness of the variable stiffness bushing assembly can be varied in an even more efficient manner.

Preferably, the axially inner end of one of the outer yokes is provided with a small diameter portion (32), and the intermediate tubular member abuts against an annular shoulder surface (35) defined at a base end of the small diameter portion of the one of the outer yokes at a first axial end thereof, and against the axially inner end of another of the outer yokes at a second axial end thereof.

Thereby, the intermediate tubular member can be retained in a favorable manner, and the sealing of the communication passage can be simplified.

According to another aspect of the present invention, the elastic member further defines a pair of second liquid chambers (141) that circumferentially alternate with the first liquid chambers (140), and the intermediate tubular member (129) further includes a central ring (129C) that partitions the annular gap into an axially separated two parts, wherein the first communication passage (146A) is defined by a part of the annular gap located on one side of the central ring, and a second communication passage (146B) communicating the second liquid chambers to each other is defined by a part of the annular gap located on another side of the central ring. Preferably, the central ring is made of material having a high magnetic permeability.

Thereby, the variable stiffness bushing assembly provides a variable stiffness in two different directions. Furthermore, the stiffness of the variable stiffness bushing assembly may be varied from one direction to another. When the central ring is made of material having a high magnetic permeability, the efficiency of the magnetic circuit can be improved.

Preferably, the axially inner end of each outer yoke is provided with a small diameter portion (132), and the intermediate tubular member includes a pair of cylindrical parts each abutting against an annular shoulder surface defined at a base end of the small diameter portion of a corresponding one of the outer yokes at a first axial end thereof, and against the central ring at a second axial end thereof.

Thereby, the intermediate tubular member can be retained in a favorable manner, and the sealing of the communication passage can be simplified.

Preferably, each cylindrical part is provided with a protruding portion (142) that blocks a part of the annular gap defined between the corresponding outer yoke and the central ring, and a pair of openings (143) passed radially therethrough in parts thereof adjoining respective circumferential ends of the protruding portion, the protruding portion of one of the cylindrical parts being offset from the protruding portion of the other cylindrical part by about 90 degrees as seen in an axial direction.

Thereby, the first liquid chambers can be communicated with each other and the second liquid chambers can be communicated with each other in a mutually independent manner in a high space efficient manner.

Preferably, the first liquid chambers oppose each other in a first direction which is orthogonal to a central axial line (X) of the inner tubular member, and the second liquid chambers oppose each other in a second direction which is orthogonal to both the first direction and the central axial line.

Thereby, the stiffness of the variable stiffness bushing assembly can be changed in two directions orthogonal to the axial line.

Preferably, the coil includes a pair of coils that are axially aligned with each other, and the annular gap defined between the outer yokes extend into a gap defined between the two coils, the protruding portion of the intermediate tubular member extending into the gap between the two coils.

Since the annular gap defined between the outer yokes extend into a gap defined between the two coils, the communication passage extends radially further inward from the opposing ends of the outer yokes, and thus, the magnetic field generated by the coils can be applied to the magnetic fluid flowing over a wider area so that the magnetic efficiency can be further improved.

Preferably, the elastic member consists of a pair of cylindrical parts that axially abut against each other in a mutually aligned relationship, the first liquid chambers being formed by recesses which are recessed from a mutually opposing axial ends of the two cylindrical parts.

Thereby, the manufacturing process for the elastic member internally defining the liquid chamber can be facilitated.

According to another aspect of the present invention, there is provided a variable stiffness bushing assembly (212), comprising: an inner tubular member (21); an outer tubular member (23) coaxially surrounding the inner tubular member with an annular space defined between the inner tubular member and the outer tubular member; and an elastic member (24) connected between the inner tubular member and the outer tubular member; wherein the inner tubular member includes a tubular yoke (25), a pair of coils (226A, 226B) coaxially wound around the yoke and axially aligned with each other to define a gap (SC) therebetween, the pair of coils being configured to generate magnetic fields directed in opposite directions, the elastic member internally defines a pair of liquid chambers (40A, 40B) which are communicated with each other via a communication passage (245) provided by the gap defined between the pair of coils, the pair of liquid chambers and the communication passage being filled with a magnetic fluid (50) having a viscosity that changes in dependence on an intensity of a magnetic field applied thereto.

Thereby, since the communication passage connecting the liquid chambers is provided by the gap defined between the axially aligned two coils, a magnetic field can be applied to the magnetic fluid flowing through the communication passage without requiring the passage to be placed within each coil.

Preferably, the variable stiffness bushing assembly further comprises an intermediate tubular member (229) made of material having a low magnetic permeability and surrounding the gap (SC) defined between the pair of coils, wherein the intermediate tubular member is provided with a protruding portion (242) that blocks a part of the gap defined between the pair of coils, and a pair of openings (41) passed radially therethrough in parts thereof adjoining respective circumferential ends of the protruding portion and communicating with the respective liquid chambers.

Thereby, the protruding portion that blocks a part of the gap defined between the pair of coils allows the communication passage between the two fluid chambers to be exclusively provided as a single arcuate passage. As a result, the magnetic field is efficiently applied to the magnetic fluid flowing through the communication passage, and the stiffness of the variable stiffness bushing assembly can be varied in an even more efficient manner.

The present invention thus provides a variable stiffness bushing assembly that can maximize the intensity of the magnetic field that is applied to the passage of the magnetic fluid without requiring the passage to be placed within the coil.

### BRIEF DESCRIPTION OF THE DRAWING(S)

FIG. 1 is a perspective view of a rear wheel suspension device incorporated with a variable stiffness bushing assembly according to an embodiment of the present invention;

FIG. 2 is a perspective view of the variable stiffness bushing assembly;

FIG. 3 is an exploded perspective view of the variable stiffness bushing assembly;

FIG. 4 is a cross sectional view of the variable stiffness bushing assembly;

FIG. 5 is a sectional view taken along line V-V in FIG. 4;

FIG. 6 is a sectional view taken along line VI-VI in FIG. 4 showing the direction of the magnetic flux produced by a coil of the variable stiffness bushing assembly;

FIG. 7 is a graph showing the level of cabin noise in relation to the rotational speed of the engine when the variable stiffness bushing assembly is in high stiffness and low stiffness;

FIG. 8 is a view similar to FIG. 6 showing a variable stiffness bushing assembly according to a second embodiment of the present invention;

FIG. 9A is a sectional view taken along line IXA-IXA in FIG. 8;

FIG. 9B is a sectional view taken along line IXB-IXB in FIG. 8;

FIG. 9C is a sectional view taken along line IXC-IXC in FIG. 8;

FIG. 10 is a view similar to FIG. 4 showing a variable stiffness bushing assembly according to a third embodiment of the present invention along with the direction of the magnetic flux generated by the coil thereof;

FIG. 11A is a sectional view taken along line XIA-XIA in FIGS. 10; and

FIG. 11B is a sectional view taken along line XIB-XIB in FIG. 10 showing the direction of the magnetic flux generated by the coil of the variable stiffness bushing assembly.

### BEST MODE FOR CARRYING OUT THE INVENTION

A variable stiffness bushing assembly 12 according to a preferred embodiment of the present invention as applied to a wheel suspension device of a vehicle is described in the following with reference to the appended drawings.

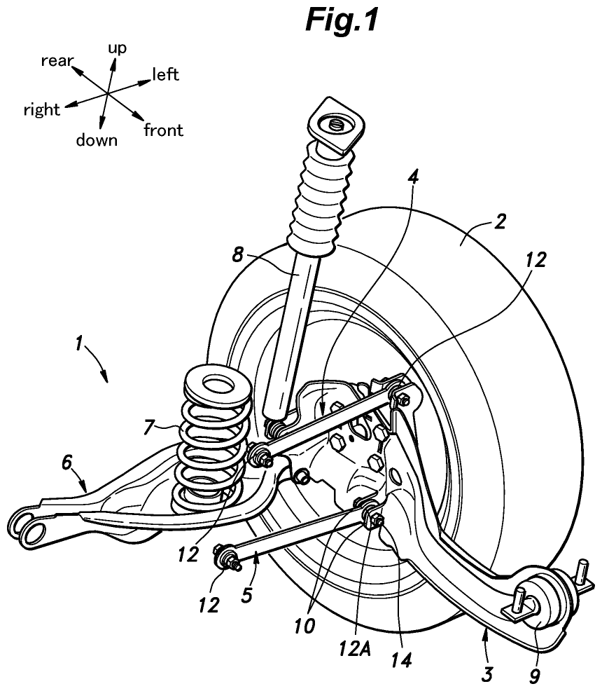

The wheel suspension device 1 shown in FIG. 1 consists of a double wishbone type independent wheel suspension device for a left rear wheel 2. As shown in FIG. 1, the wheel suspension device 1 includes a trailing arm 3, an upper arm 4, a first lower arm 5, a second lower arm 6, a spring 7, and a damper 8.

The trailing arm 3 extends in the fore and aft direction, and is pivotally supported by the vehicle body at the front end thereof via a bushing assembly 9. The left rear wheel 2 is rotatably supported at the rear end of the trailing arm 3.

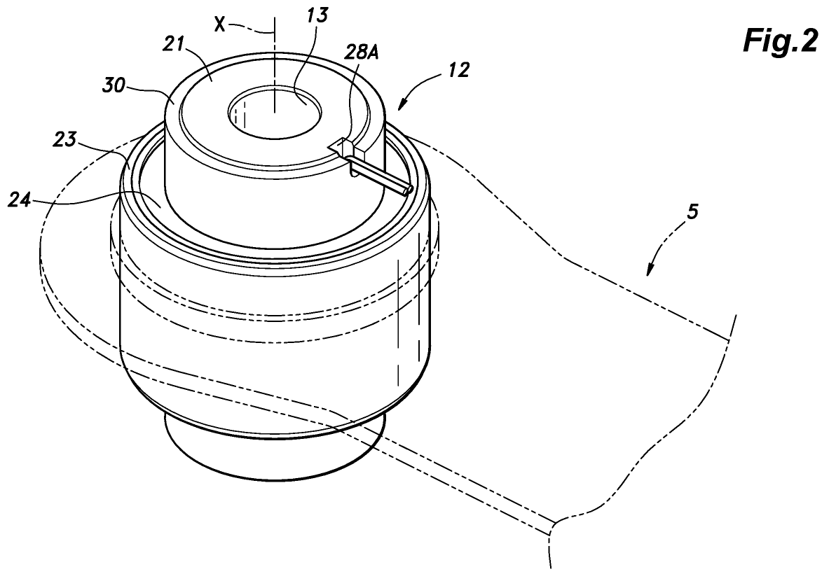

The first lower arm 5 consists of a sheet metal member extending substantially in the lateral direction, and is supported by the trailing arm 3 at the outboard end thereof and by the vehicle body at the inboard end thereof. In the present embodiment, the trailing arm 3 is provided with a pair of support pieces 10 positioned one behind the other. The support pieces 10 are provided with through holes that are aligned with each other in the fore and aft direction. A tubular collar 11 (see FIG. 2) is provided at the outboard end of the first lower arm 5, and a tubular variable stiffness bushing assembly 12 is coaxially fitted into the collar 11. The variable stiffness bushing assembly 12 is provided with a bolt hole 13 (see FIG. 2) extending along the central axial line X thereof. As shown in FIG. 1, a bolt 14 is passed through the bolt hole 13, and the through holes of the support pieces 10 to pivotally connect the outboard end of the first lower arm 5 to the trailing arm 3. As a result, the first lower arm 5 is pivotally supported by the trailing arm 3 via the variable stiffness bushing assembly 12 at the outboard end thereof. Similarly, the inboard end of the first lower arm 5 is pivotally supported by the vehicle body via another variable stiffness bushing assembly 12.

The second lower arm 6 extends substantially laterally, and is pivotally connected to the trailing arm 3 at the outboard end thereof, and pivotally connected to the vehicle body at the inboard end thereof. The compression coil spring 7 is interposed between the second lower arm 6 and a part of the vehicle body hanging over the second lower arm 6. Similarly, the damper 8 is interposed between the second lower arm 6 and the part of the vehicle body hanging over the second lower arm 6. The spring 7 and the damper 8 jointly function as a shock absorber that absorbs the vibration transmitted from the road surface to the vehicle body.

The upper arm 4 extends substantially laterally similarly as the first lower arm 5, and is pivotally connected to the trailing arm 3 via yet another variable stiffness bushing assembly 12 at the outboard end thereof, and pivotally connected to the vehicle body via yet another variable stiffness bushing assembly 12 at the inboard end thereof, in a similar manner as the first lower arm 5.

These variable stiffness bushings 12 have an essentially identical structure. The following disclosure is directed only to the variable stiffness bushing assembly 12 provided on the first lower arm 5 since the essentially same disclosure is applicable to the remaining variable stiffness bushing assemblies 12. In the following description, the axial line X of the variable stiffness bushing assembly 12 is assumed as extending in the vertical direction for the convenience of description, but the direction of the axial line X of the variable stiffness bushing assembly 12 may be directed in the fore and aft direction or any other direction in the real applications.

### First Embodiment

As shown in FIG. 2, the variable stiffness bushing assembly 12 according to the first embodiment includes an inner tubular member 21 that defines a bolt hole 13, an outer tubular member 23 that surrounds the inner tubular member 21 in a coaxial relationship with an annular gap defined therebetween, and an elastic member 24 that is interposed between the inner tubular member 21 and the outer tubular member 23, and connects the inner tubular member 21 and the outer tubular member 23 to each other.

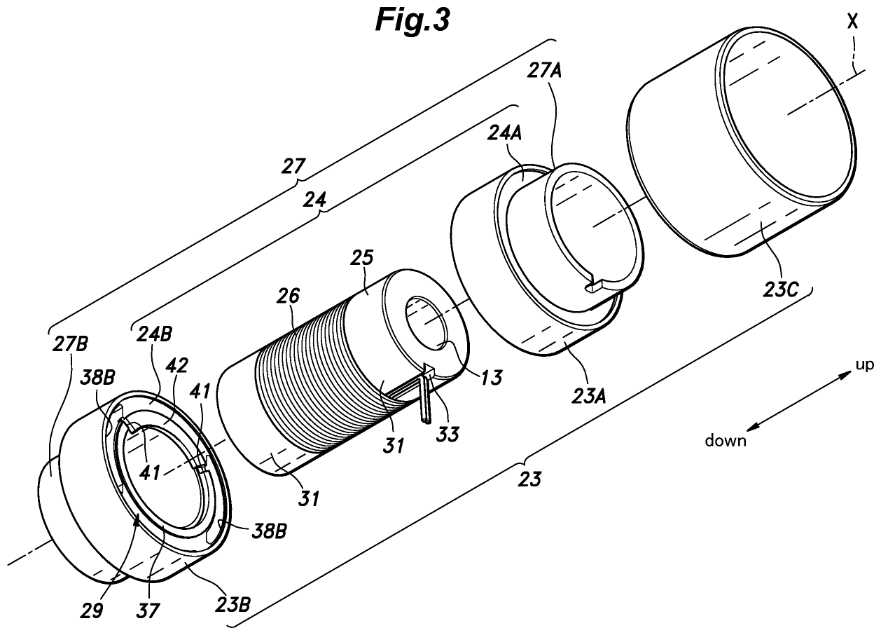

As shown in FIG. 2, the inner tubular member 21 extends along the axial line X (axial direction X). As shown in FIGS. 3 to 5, the inner tubular member 21 includes a tubular inner yoke 25 arranged along the axial line X, a coil 26 wound coaxially around the outer periphery of the inner yoke 25, and a pair of outer yokes 27 disposed coaxially with respect to the inner tubular member 21, and each having an axially outer end connected to a corresponding axial end part (or a radial flange 31) of the inner yoke 25 and an axially inner end opposing the other outer yoke 27. The inner tubular member 21 further includes an intermediate tubular member 29 that is fitted into an annular gap defined between the opposing ends of the outer yokes 27, and defines an inner circumferential surface and an outer circumferential surface substantially flush with those of the outer yokes 27.

The inner yoke 25 and the outer yokes 27 are made of a material having a high magnetic permeability, and typically consists of a metallic material exhibiting ferromagnetism such as iron. In this embodiment, the inner yoke 25 and the outer yokes 27 are made of soft iron.

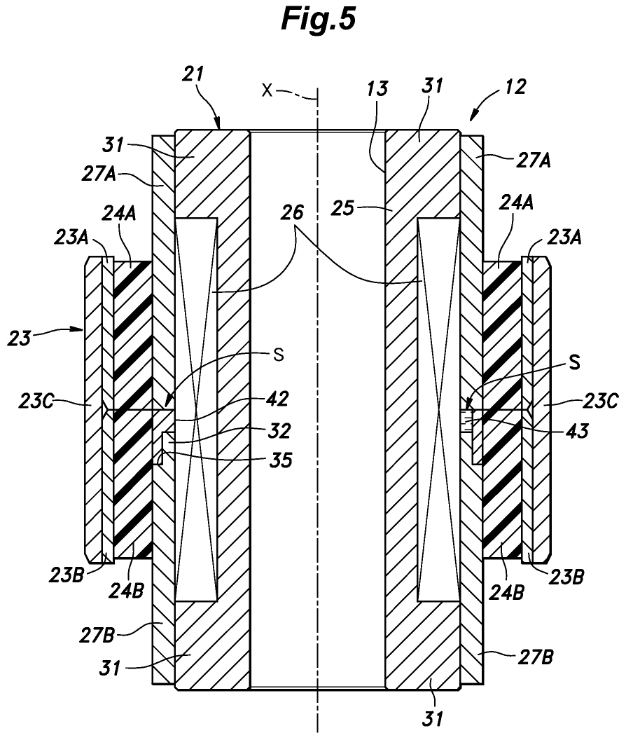

The coil 26 is formed by winding a coated copper wire around the central portion of the outer periphery of the inner yoke 25, and extends in the axial direction X. As shown in FIG. 5, the upper end and the lower end of the inner yoke 25 are each provided with a flange 31 projecting in the radially outward direction. The outer peripheral surface of the flange 31 is flush with the outer peripheral surface of the coil 26, and abuts against and attached to the inner circumferential surface of the corresponding outer yoke 27. In the present embodiment, as shown in FIG. 3, at least one of the flanges 31 is provided with a lead slot 33 that is recessed in the radially inward direction so that lead wires connected to the two ends of the coil 26 are drawn out of the inner tubular member 21 via the lead slot 33.

As shown in FIG. 3, the outer yokes 27 each have a tubular shape extending along the axial line X. As shown in FIG. 5, each outer yoke 27 is connected to the upper end or the lower end of the inner yoke 25 at an axially outer end part thereof. Thus, the axially inner ends of the outer yokes 27 oppose each other at a substantially central portion with respect to the axial direction. Hereinafter, the outer yoke 27 connected to the upper portion of the inner yoke 25 may be referred to as an upper outer yoke 27A, and the outer yoke 27 connected to the lower portion of the inner yoke 25 may be referred to as a lower outer yoke 27B.

The upper outer yoke 27A has an inner diameter substantially equal to the outer diameter of the upper flange 31 and the coil 26. The upper portion of the inner yoke 25 and the upper portion of the coil 26 are received in the inner bore of the upper outer yoke 27A. The outer peripheral surface of the upper flange 31 and the upper outer peripheral surface of the coil 26 are thus in contact with the inner peripheral surface of the upper outer yoke 27A so that no gap is defined therebetween.

The lower outer yoke 27B has an inner diameter substantially equal to the outer diameter of the lower flange 31 and the coil 26. The lower part of the inner yoke 25 and the lower part of the coil 26 are received in the inner bore of the lower outer yoke 27B. The outer peripheral surface of the lower flange 31 and the lower outer peripheral surface of the coil 26 are thus in contact with the inner peripheral surface of the lower outer yoke 27B so that no gap is defined therebetween. The outer diameter of the lower outer yoke 27B is substantially equal to the outer diameter of the upper outer yoke 27A.

The coil 26 is thus received in a recess which is recessed radially inward in part of the inner yoke 25 located between the upper flange 31 and the lower flange 31.

As shown in FIG. 5, the upper end portion of the lower outer yoke 27B is provided with a small diameter portion 32 which has a smaller diameter than the remaining part of the lower outer yoke 27B so that an annular shoulder surface 35 facing upward is defined at the lower base end of the small diameter portion 32. The upper end of the small diameter portion 32 is located slightly below the lower end of the upper outer yoke 27A, and an intermediate tubular member 29 is fitted in the gap defined between the small diameter portion 32 and the upper outer yoke 27A.

The intermediate tubular member 29 is a member made of a non-magnetic material (preferably, a non-magnetic metal) having a lower magnetic permeability than that of the material forming the inner yoke 25. Specifically, the intermediate tubular member 29 is preferably made of aluminum.

The intermediate tubular member 29 has an outer diameter substantially equal to the outer diameter of the outer yokes 27. The inner periphery of the intermediate tubular member 29 is provided with a protruding portion 42 which protrudes radially inward over a certain angular range around the central axial line X of the inner tubular member 21, and otherwise has a same inner diameter as the outer diameter of the small diameter portion 32. The small diameter portion 32 is thus fitted in the inner bore of the lower part of the intermediate tubular member 29. The intermediate tubular member 29 abuts against the annular shoulder surface 35 at the lower end so as to fill the axial gap defined between the annular shoulder surface 35 and the lower end surface of intermediate tubular member 29.

The inner peripheral surface of the intermediate tubular member 29 is in contact with the outer peripheral surface of the small diameter portion 32 over the entire periphery of the lower part thereof, and the space between the inner peripheral surface of the intermediate tubular member 29 and the outer peripheral surface of the small diameter portion 32 is sealed. It should be noted that the upper part of the intermediate tubular member 29 surrounds the coil 26 with a predetermined gap. The upper end of the intermediate tubular member 29 abuts against the lower axial end surface of the upper outer yoke 27A, and the gap between the upper end of the intermediate tubular member 29 and the upper outer yoke 27A is sealed.

Thus, an arcuate gap S is defined in the inner tubular member 21 by the inner peripheral surface of the upper part of the intermediate tubular member 29, the outer peripheral surface of the coil 26, the lower end surface of the upper outer yoke 27A, and the upper end surface of the small diameter portion 32 of the lower outer yoke 27B. This gap S is absent where the protruding portion 42 is provided. Thus, this gap S extends in the circumferential direction by an angle substantially greater than 180 degrees as will be discussed hereinafter. The upper outer yoke 27A and the lower outer yoke 27B oppose each other with the gap S therebetween. The outer diameter of the intermediate tubular member 29 is substantially equal to the outer diameter of the upper outer yoke 27A and the outer diameter of the lower outer yoke 27B.

As shown in FIG. 3, the outer tubular member 23 includes an upper outer tubular member 23A, a lower outer tubular member 23B, and a tubular holder member 23C surrounding the upper outer tubular member 23A and the lower outer tubular member 23B. The upper outer tubular member 23A and the lower outer tubular member 23B are identical in shape, and axially abut against each other along the axial line X. The upper outer tubular member 23A and the lower outer tubular member 23B are snugly received in the tubular holder member 23C.

The inner diameter of the outer tubular member 23 (the inner diameter of the upper outer tubular member 23A and the lower outer tubular member 23B) is substantially greater than the outer diameter of the intermediate tubular member 29, the outer diameter of the lower outer yoke 27B, and the outer diameter of the upper outer yoke 27A. In the present embodiment, the intermediate tubular member 29, the outer diameter of the lower outer yoke 27B, and the outer diameter of the upper outer yoke 27A are all disposed in a coaxial relationship, and have a same outer diameter. Thus, the outer tubular member 23 surrounds the intermediate tubular member 29, the lower outer yoke 27B, and the upper outer yoke 27A, and an annular space is defined between the outer tubular member 23 and the inner tubular member 21.

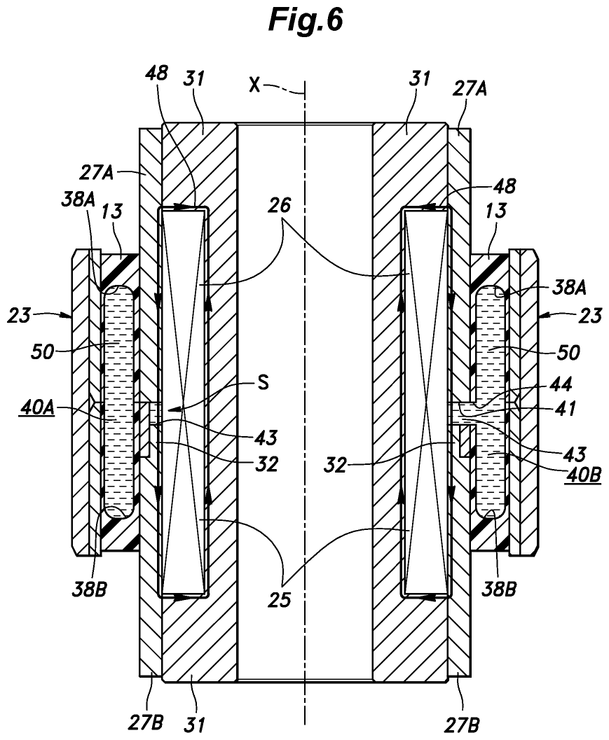

The elastic member 24 is made of an elastic material such as rubber and elastomer, and is fitted in the annular space between the inner tubular member 21 and the outer tubular member 23 as shown in FIG. 2. More specifically, as shown in FIG. 3, the elastic member 24 includes an upper elastic member 24A and a lower elastic member 24B. The upper elastic member 24A is a tubular member, and is in contact with the outer peripheral surface of the upper outer yoke 27A at the inner peripheral surface thereof, and with the inner peripheral surface of the upper outer tubular member 23A at the outer peripheral surface thereof. As shown in FIG. 6, the lower surface of the upper elastic member 24A is formed with a pair of upper recesses 38A that are recessed upward at diametrically opposing positions with respect to the central axial line X of the inner tubular member 21.

The lower elastic member 24B is a tubular member similar to the upper elastic member 24A. The lower elastic member 24B is in contact with the outer peripheral surface of the lower outer yoke 27B and the outer peripheral surface of the intermediate tubular member 29 at the inner peripheral surface thereof, and with the inner peripheral surface of the lower outer tubular member 23B at the outer peripheral surface thereof. The upper surface of the lower elastic member 24B is formed with a pair of lower recesses 38B that are recessed downward at positions corresponding to the upper recesses 38A, respectively.

The lower surface of the upper elastic member 24A and the upper surface of the lower elastic member 24B are joined to each other so that a pair of liquid chambers 40 (which may be referred to as the first liquid chambers 40A and 40B, respectively) are defined by the upper recess 38A and the lower recess 38B. In other words, a pair of first liquid chambers 40 are defined in the elastic member 24 filling the annular space between the outer tubular member 23 and the inner tubular member 21. As shown in FIG. 5, the two first liquid chambers 40A and 40B diametrically oppose each other with respect to the central axial line X.

In the present embodiment, the first liquid chambers 40A and 40B oppose each other along the lengthwise direction of the arm (the first lower arm 5 or the upper arm 4) which is fitted with the variable stiffness bushing assemblies 12 or along the lateral direction of the vehicle.

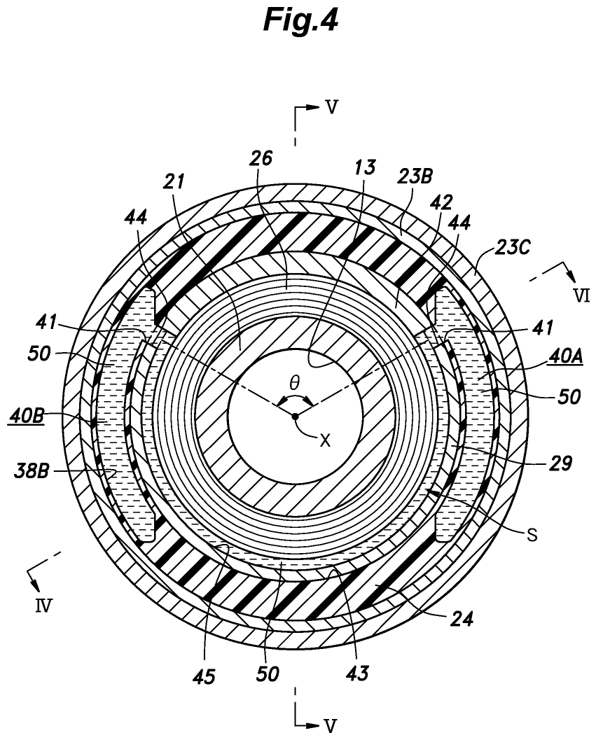

As shown in FIGS. 4 and 6, two openings 41 are formed the intermediate tubular body 37 by forming notches in the upper edge of the intermediate tubular body 37 immediately radially inward of the first liquid chambers 40A and 40B, respectively. The two openings 41 are circumferentially spaced apart from each other, and are located at the same height with respective to the vertical direction. As shown in FIG. 4, the angle θ formed by two radial lines passing the axial line X and the centers of the openings 41 in a top view is substantially less than 180 degrees. The angle θ may be between 30 degrees and 170 degrees.

Between the two openings 41 of the intermediate tubular member 29, a protruding portion 42 that protrudes radially inward extends in the circumferential direction. The protruding portion 42 has an arcuate shape (of a fan shape) when viewed from above. In the present embodiment, the protruding portion 42 is formed along the shorter one of the two paths connecting the two openings 41 in the circumferential direction along the outer circumferential surface of the tubular when viewed from above. As can be readily appreciated, the protruding portion 42 extends around the axial line X.

As shown in FIG. 5, the protruding portion 42 fits into the gap S defined between the upper outer yoke 27A and the lower outer yoke 27B. The protruding portion 42 abuts against the upper outer yoke 27A at the upper edge thereof, and the gap between the upper surface of the protruding portion 42 and the lower surface of the upper outer yoke 27A is closed. The protruding portion 42 abuts against the upper end surface of the lower outer yoke 27B (more specifically, the upper end surface of the small diameter portion 32) at the lower edge thereof, and the gap defined between the lower surface of the protruding portion 42 and the upper end surface of the small diameter portion 32 is closed. As a result, an arcuate passage or a circumferential passage 43 is defined the inner tubular member 21 by an outer peripheral surface of the coil 26, an inner peripheral surface of the intermediate tubular member 29, a lower end surface of the upper outer yoke 27A, an upper end surface of the small diameter portion 32 of the lower outer yoke 27B, and the circumferential end surfaces of the protruding portion 42. The upper outer yoke 27A and the lower outer yoke 27B oppose each other in the vertical direction via the circumferential passage 43.

As shown in FIG. 4, the elastic member 24 is provided with a pair of connecting passages 44 that connect the first liquid chambers 40A and 40B to the corresponding openings 41, respectively. Thereby, the first liquid chambers 40A and 40B are communicated with each other via a communication passage 45 including the connecting passages 44, the openings 41, and the circumferential passage 43.

As shown in FIG. 6, the axial dimension of the circumferential passage 43 is substantially smaller than the axial dimension of the liquid chamber 40, and the radial dimension of the circumferential passage 43 is substantially smaller than the radial dimension of the liquid chamber 40. The axial dimension of the circumferential passage 43 is preferably between 0.1 times 0.5 times of the axial dimension of the liquid chamber 40. In this embodiment, the axial dimension of the circumferential passage 43 is about 0.2 times the axial dimension of the liquid chamber 40.

As shown in FIG. 4, the magnetic fluid 50 is contained in the first liquid chambers 40A and 40B, and the communication passage 45. The magnetic fluid 50 may be an incompressible fluid containing iron particles dispersed in a solvent such as oil, and in particular, may consist of a fluid whose viscoelasticity, particularly viscosity changes depending on the intensity of the magnetic field applied thereto such as a magnetic viscoelastic fluid (MRF: Magnetorheological Fluid) and a magnetic viscoelastic compound (MRC: Magnetorheological Compound). In the present embodiment, MRC is used as the magnetic fluid 50. When a magnetic field is applied to the magnetic fluid 50, the fine particles of iron are arranged in chains extending along the direction of the magnetic field to form chain clusters. As a result, the flow of the solvent in the direction perpendicular to the magnetic field is hindered by the chain clusters, and the effective viscosity of the magnetic fluid 50 increases. The magnetic fluid 50 may even become almost solid.

The mode of operation of the variable stiffness bushing assembly 12 according to this embodiment is discussed in the following. When the vehicle is steered, a load is applied to the first lower arm 5 and the upper arm 4 in lengthwise direction in either case. When the load is input to the first lower arm 5 (or the upper arm 4), the inner tubular member 21 receives a load that moves the outer tubular member 23 in the lengthwise direction of the first lower arm 5 (the upper arm 4). As a result, the elastic member 24 is deformed so that the cubic capacity of one of the liquid chambers 40 increases while the cubic capacity of the other liquid chamber 40 decreases. Due to the deformation of the elastic member 24, the magnetic fluid 50 contained in one of the liquid chambers 40 moves to the other liquid chamber 40 via the communication passage 45. At this time, the magnetic fluid 50 flowing in the communication passage 45 encounters resistance, and the vibration applied to the variable stiffness bushing assembly 12 is attenuated in a manner similar to a conventional fluid damper.

When an electric current is supplied to the coil 26, a magnetic field is generated around the coil 26. FIG. 6 shows the magnetic field lines corresponding to the magnetic field generated by the coil 26. As shown in FIG. 6, the magnetic field lines form a loop that sequentially passes through the inner tubular member 21, the upper outer yoke 27A, and the lower outer yoke 27B. As a result, the inner tubular member 21, the upper outer yoke 27A, and the lower outer yoke 27B form a magnetic circuit 48 that concentrates the magnetic field in the communication passage 45 located between the upper outer yoke 27A and the lower outer yoke 27B.

The viscosity of the magnetic fluid 50 in the communication passage 45 increases with the application of a magnetic field. As a result, the resistance applied to the magnetic fluid 50 flowing in the communication passage 45 increases so that the resistance to the relative movement between the inner tubular member 21 and the outer tubular member 23 increases, or in other words, the stiffness of the variable stiffness bushing assembly 12 increases. Thus, by controlling the voltage applied to the coil 26, the stiffness of the variable stiffness bushing assembly 12 can be controlled.

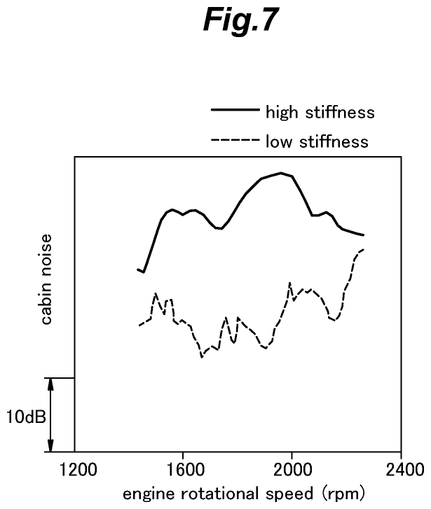

Next, the advantages of the variable stiffness bushing assembly 12 of this embodiment are discussed in the following. When the stiffness of the variable stiffness bushing assembly 12 provided in the upper arm 4 (or the lower arms 5 and 6) of the wheel suspension device 1 is changed, the intensity of the noise transmitted from the engine to the vehicle interior changes. FIG. 7 shows the relationship between the engine rotational speed and the intensity of the noise (in decibels) transmitted to the passenger compartment when the stiffness of the variable stiffness bushing assembly 12 is high (solid line) and low (broken line). As shown in FIG. 7, when the stiffness of the variable stiffness bushing assembly 12 is lowered, vibration transmitted from the road surface to the vehicle body is absorbed by the variable stiffness bushing assembly 12, and vibration noise in the vehicle interior is reduced.

On the other hand, when the stiffness of the variable stiffness bushing assembly 12 is reduced, the handling of the vehicle may be impaired. In the variable stiffness bushing assembly 12 according to the present embodiment, the stiffness of the variable stiffness bushing assembly 12 can be increased when the vehicle handling is desired to be improved, and the stiffness of the variable stiffness bushing assembly 12 can be decreased when the vibration noise is desired to be reduced. Thereby, vibration noise can be reduced while ensuring a favorable vehicle handling depending on the need.

In the variable stiffness bushing assembly 12 of the present embodiment, the stiffness thereof can be changed by changing the viscosity of the magnetic fluid 50 by supplying an electric current through the coil 26. In this conjunction, it is desirable that the magnetic field generated by the coil 26 is concentrated in the flow passage of the magnetic fluid 50.

The upper outer yoke 27A and the lower outer yoke 27B are connected to the respective axially outer end parts of the inner yoke 25, and oppose each other via the communication passage 45. The inner tubular member 21, the upper outer yoke 27A, and the lower outer yoke 27B are each made of a material having a high magnetic permeability, and the magnetic field lines generated by the coil 26 pass through the communication passage 45 by being guided by the inner yoke 25, the upper outer yoke 27A and the lower outer yoke 27B. In other words, the inner yoke 25, the upper outer yoke 27A, and the lower outer yoke 27B form a magnetic circuit 48 that minimizes leakage of the magnetic flux generated by the coil 26 and concentrates the magnetic field in the communication passage 45. Thereby, the stiffness of the variable stiffness bushing assembly 12 can be changed in relation to the current flowing through the coil 26 in a highly efficient manner.

In order to maximize the variable range of the stiffness of the variable stiffness bushing assembly 12, it is preferable to minimize the cross sectional area of the communication passage 45 and maximize the circumferential length of the communication passage 45. In the present embodiment, since the first liquid chambers 40A and 40B are provided at positions separated in the circumferential direction, the communication passage 45 connecting them can be elongated in the circumferential direction. As a result, a magnetic field can be applied to the communication passage 45 in an efficient manner so that the movement of the magnetic liquid between the two liquid chambers 40 can be more effectively impeded. Thereby, the variable range of the stiffness of the variable stiffness bushing assembly 12 can be maximized.

The two openings 41 are connected by the single arcuate circumferential passage 43, instead of a pair of circumferential passages individually connecting the two openings 41 to each other. The effective cross sectional area of the passage connecting the two liquid chambers 40 can be reduced in the former case as compared to the latter case. Therefore, the present embodiment allows the variable range of the stiffness of the variable stiffness bushing assembly 12 to be maximized.

Further, since the longer one of the two possible circumferential passages for communicating the two liquid chambers 40 is selected for the circumferential passage 43 of the present embodiment while the shorter one of the two possible circumferential passages for communicating the two liquid chambers 40 is blocked by the protruding portion 42, the length of the circumferential passage 43 (communication passage 45) can be maximized, and the variable range of the stiffness of the variable stiffness bushing assembly 12 to be maximized.

### Second Embodiment

The variable stiffness bushing assembly 112 of the second embodiment differs from the variable stiffness bushing assembly 12 of the first embodiment only in the configurations of the outer yoke 127 of the inner tubular member 121, the intermediate tubular member 129 and the elastic member 124, but is otherwise similar to the variable stiffness bushing assembly 12 of the first embodiment. Therefore, other components of the second embodiment are denoted with like numerals to those of the first embodiment without necessarily repeating the description of such parts.

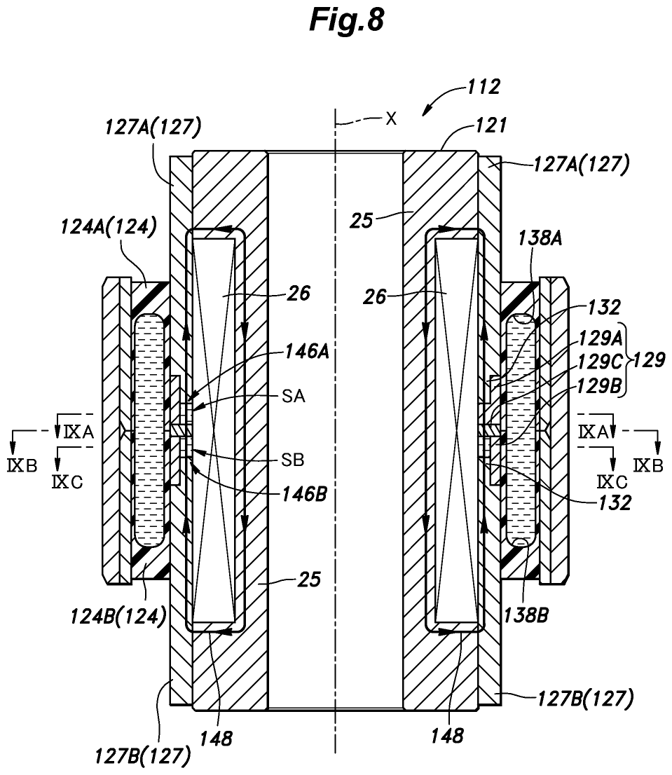

As shown in FIG. 8, the outer yoke 127 has a tubular shape as in the first embodiment, and is fitted on and attached to the outer peripheral surface of the flanges 31 provided on the upper and lower end portions of the inner yoke 25, respectively. The outer yoke 127 consists of two parts or an upper outer yoke 127A and a lower outer yoke 127B that axially oppose each other. In this embodiment, the upper outer yoke 127A and the lower outer yoke 127B are both similar in shape to the lower outer yoke 27B of the first embodiment, and are arranged so as to be mirror images of each other. The lower end of the upper outer yoke 127A and the upper end of the lower outer yoke 127B are provided with small diameter portions 132 that project toward each other along the axial line X.

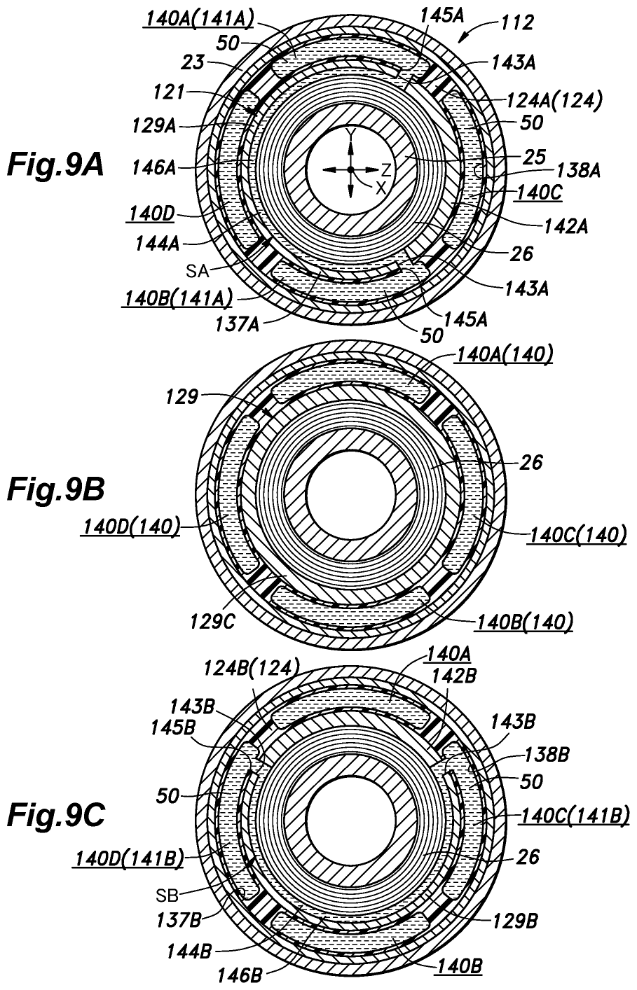

The intermediate tubular member 129 has a substantially tubular shape having a center line extending along the axial line X, and is positioned between the upper outer yoke 127A and the lower outer yoke 127B as in the first embodiment. In the present embodiment, the intermediate tubular member 129 consists of an annular central portion 129C (see FIG. 9B) centered around the axial line X, a substantially tubular upper intermediate tubular member 129A axially abutting against the upper surface of the annular central portion 129C, and a substantially tubular lower intermediate tubular member 129B axially abutting against the lower surface of the annular central portion 129C, all in a coaxial relationship to the inner yoke 25.

The central portion 129C is made of metal or other material having a high magnetic permeability. The central portion 129C has an outer diameter substantially equal to the outer diameter of the upper outer yoke 127A and the lower outer yoke 127B. The central portion 129C has an inner diameter substantially equal to the outer diameter of the coil 26. The inner peripheral surface of the central portion 129C is substantially in contact with the outer peripheral surface of the coil 26.

The lower intermediate tubular member 129B is made of a metal or other material having a low magnetic permeability, such as aluminum, and may have the same shape as the intermediate tubular member 29 of the first embodiment. Similarly as in the first embodiment, the lower half of the inner bore of the lower intermediate tubular member 129B is fitted on the small diameter portion 132 formed in the upper end of the lower outer yoke 127B. The lower intermediate tubular member 129B is provided with a protruding portion 142B that protrudes radially inward from an upper part of the inner peripheral surface of the lower intermediate tubular member 129B and extends circumferentially by an angle substantially smaller than 180 degrees. Thus, the lower outer yoke 127B and the central portion 129C oppose each other via the lower intermediate tubular member 129B (see FIG. 8). More specifically, the lower end of the lower intermediate tubular member 129B abuts against an annular shoulder surface defined at the base end of the small diameter portion 132, and the lower end of the protruding portion 142B abuts against the upper end surface of the small diameter portion 132 of the lower outer yoke 127B. Thus, a gap SB is created between the upper end of the small diameter portion 132 and the lower end of the central portion 129C where the protruding portion 142B is absent (see FIG. 9C).

The upper intermediate tubular member 129A is also made of a metal or other material having a low magnetic permeability, such as aluminum, and has the same shape as the lower intermediate tubular member 129B. The upper intermediate tubular member 129A is angularly offset from the lower intermediate tubular member 129B by 90 degrees around the axial line X. Similarly as the lower intermediate tubular member 129B, the lower half of the inner bore of the upper intermediate tubular member 129A is fitted on the small diameter portion 132 formed in the lower end of the upper outer yoke 127A. The upper intermediate tubular member 129A is provided with a protruding portion 142A that protrudes radially inward from a lower part of the inner peripheral surface of the upper intermediate tubular member 129A and extends circumferentially by an angle substantially smaller than 180 degrees. Thus, the upper outer yoke 127A and the central portion 129C oppose each other via the upper intermediate tubular member 129A (see FIG. 8). More specifically, the lower end of the upper intermediate tubular member 129A abuts against an annular shoulder surface defined at the base end of the small diameter portion 132, and the upper end of the protruding portion 142A abuts against the lower end surface of the small diameter portion 132 of the upper outer yoke 127A. Thus, a gap SA is created between the lower end of the small diameter portion 132 and the upper end of the central portion 129C where the protruding portion 142A is absent (see FIG. 9A).

As shown in FIG. 8, as in the first embodiment, an annular space is defined between the inner tubular member 121 and the outer tubular member 123, and this space is filled with an elastic member 124 made of elastic material such as rubber. The elastic member 124 is connected to the outer circumferential surface of the inner tubular member 121 at the inner circumferential surface thereof, and is connected to the inner circumferential surface of the outer tubular member 123 at the outer circumferential surface thereof. As a result, the inner tubular member 121 and the outer tubular member 123 are connected to each other via the elastic member 124.

As in the first embodiment, the elastic member 124 includes a tubular upper elastic member 124A, and a tubular lower elastic member 124B. As shown in FIGS. 8 and 9A, the upper elastic member 124A is provided with four upper recesses 138A that are recessed upward from the lower surface as in the first embodiment. The four upper recesses 138A are arranged at equal intervals in the circumferential direction. More specifically, the two of the upper recesses 138A oppose each other in the first direction Y around the axial line X, and the other two upper recesses 138A oppose each other in the second direction Z which is orthogonal to the first direction Y around the axial line X. In the present embodiment, the variable stiffness bushing assembly 112 is attached to the suspension arm so that the lengthwise direction of the suspension arm coincides with the first direction Y.

As shown in FIGS. 8 and 9C, the lower elastic member 124B is provided with four lower recesses 138B that are recessed downward from the upper surface thereof as in the first embodiment. The four lower recesses 138B are aligned with the corresponding upper recesses 138A, and are therefore arranged at equal intervals in the circumferential direction.

As shown in FIG. 9A, the lower surface of the upper elastic member 124A and the upper surface of the lower elastic member 124B are joined to each other, and four liquid chambers 140 are defined jointly by the upper recess 38A and the lower recess 38B. More specifically, the four liquid chambers 140 include two first liquid chambers 140A and 140B (which may be referred to as first liquid chambers 141A) opposing each other in the first direction Y via the axial line X, and two second liquid chambers 140C and 140D (which may be referred to as second liquid chambers 141B) opposing each other in the second direction Z via the axial line X. Thus, the elastic member 124 internally defines the first liquid chambers 141A which are arranged along the first direction Y, and the second liquid chambers 141B which are arranged along the second direction Z in the annular space between the inner tubular member 121 and the outer tubular member 123 as shown in FIG. 8B.

As shown in FIG. 9A, the annular gap SA is filled with and closed by the protruding portion 142A over the corresponding circumferential range, but is otherwise provides an arcuate first circumferential passage 144A in the inner tubular member 121.

Similarly as the intermediate tubular member 29 of the first embodiment, the upper intermediate tubular member 129A is provided with a pair of first openings 143A directed in the radial direction at the two circumferential ends of the protruding portion 142A, respectively. Further, the upper elastic member 124A is formed with a pair of connecting passages 145A communicating the first liquid chambers 141A with the corresponding first openings 143A, respectively. Thus, the first liquid chambers 141A are communicated with each other via a first communication passage 146A consisting of the first openings 143A, the connecting passages 145A, and the first circumferential passage 144A.

As shown in FIG. 9C, the annular gap SB is filled with and closed by the protruding portion 142B over the corresponding circumferential range, but is otherwise provides an arcuate second circumferential passage 144B in the inner tubular member 121. As mentioned earlier, the protruding portion 142B of the lower intermediate tubular member 129B is angularly offset by 90 degrees in counterclockwise direction with respect to the protruding portion 142A of the upper intermediate tubular member 129A when viewed from above.

Similarly as the upper intermediate tubular member 129A, the lower intermediate tubular member 129B is provided with a pair of second openings 143B directed in the radial direction at the two circumferential ends of the protruding portion 142B, respectively. Further, the lower elastic member 124B is formed with a pair of connecting passages 145B communicating the second liquid chambers 141B with the corresponding second openings 143B, respectively. Thus, the second liquid chambers 141B are communicated with each other via a second communication passage 146B consisting of the second openings 143B, the connecting passages 145B, and the second circumferential passage 144B.

As in the first embodiment, each of the first liquid chambers 141A, the second liquid chambers 141B, the first communication passage 146A, and the second communication passage 146B is filled with the magnetic fluid 50.

The features and advantages of the variable stiffness bushing assembly 112 according to the second embodiment are described in the following. When a current is supplied to the coil 26, magnetic field lines generated by the coil 26 are formed in a loop that passes through the inner yoke 25, the upper outer yokes 127A, the central portion 129C, and the lower outer yoke 127B as shown in FIG. 8. At this time, the magnetic field lines pass vertically through the upper outer yoke 127A, the central portion 129C, and the lower outer yoke 127B. Therefore, the inner yoke 25, the upper outer yoke 127A, and the lower outer yoke 127B form a magnetic circuit 148 that concentrates the magnetic field in the gap SA and the gap SB that are defined between the upper outer yoke 127A and the lower outer yoke 127B. As a result, the viscosity of the magnetic fluid 50 flowing through the first communication passage 146A and the second communication path 146B located in the gap SA and the gap SB, respectively, is increased in an efficient manner.

When a load is applied to the inner tubular member 121 in a direction parallel to the first direction Y, the inner tubular member 121 moves in the first direction Y with respect to the outer tubular member 23. As a result, the cubic capacity of one of the first liquid chambers 141A is increased while the cubic capacity of the other first liquid chamber 141A is decreased in a complementary manner, and the magnetic fluid 50 moves between the first liquid chambers 141A.

When an electric current is supplied to the coil 26, the viscosity of the magnetic fluid 50 inside the first communication passage 146A is increased so that the movement of the magnetic fluid 50 between the first liquid chambers 141A is impeded. As a result, a stronger resistance against movement is applied to the inner tubular member 121 than when no or less electric current is supplied the coil 26, and the stiffness of the variable stiffness bushing assembly 112 in the first direction Y is increased. Similarly, when an electric current is passed through the coil 26, the viscosity of the magnetic fluid 50 flowing through the second communication passage 146B is increased so that the movement of the magnetic fluid 50 between the second liquid chambers 141B is impeded. As a result, the stiffness of the variable stiffness bushing assembly 112 in the second direction Z is increased. Thus, in the variable stiffness bushing assembly 112, the stiffness in two directions or in the first direction Y and the second direction Z which are orthogonal to the axial line X can be changed at the same time.

### Third Embodiment

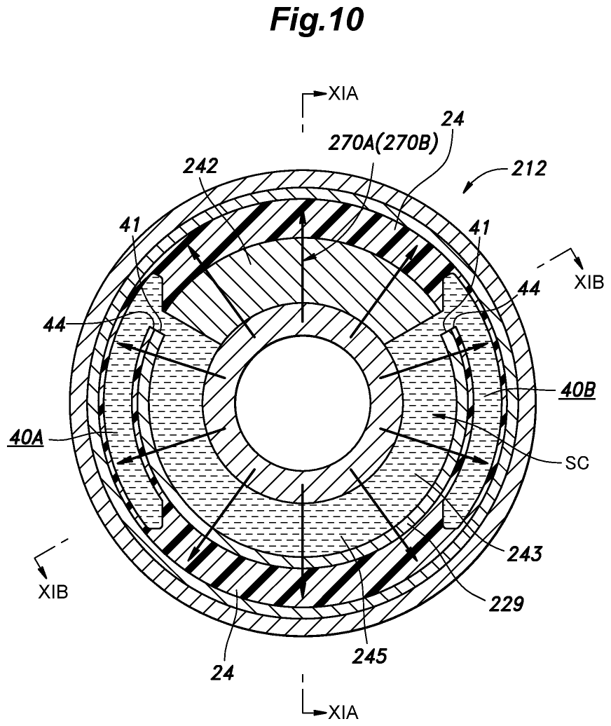

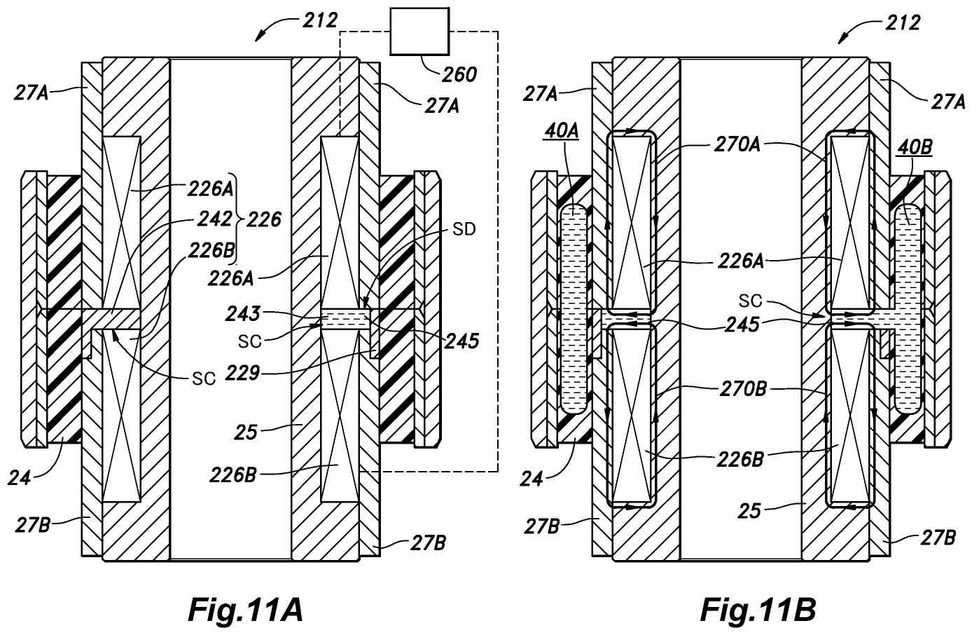

The variable stiffness bushing assembly 212 of the third embodiment differs from the variable stiffness bushing assembly 12 of the first embodiment in the shape of the intermediate tubular member 229 (see FIG. 10), and in having a pair of coils 226 (upper coil 226A and lower coil 226B) on the inner yoke 25, instead of one coil. As shown in FIGS. 11A and 11B, the upper coil 226A and the lower coil 226B oppose each other via a gap SC. The upper coil 226A and the lower coil 226B are wound in opposite directions when viewed from above.

As shown in FIG. 11A, the lower end of the upper coil 226A vertically aligns with the lower end of the upper outer yoke 27A, and the upper end of the lower coil 226B vertically aligns with the upper end of the lower outer yoke 27B. As a result, the gap SC provided between the two coils 226 also vertically aligns with the gap SD defined between the upper outer yoke 27A and the lower outer yoke 27B. As shown in FIG. 10, the gap SC between the two coils 226, and the gap SD formed between the upper outer yoke 27A and the lower outer yoke 27B are surrounded by the intermediate tubular member 229 from a radially outer side.

As shown in FIG. 10, similarly as in the first embodiment, the annular space between the inner tubular member 21 and the outer tubular member 23 is filled by an elastic member 24 and a pair of first liquid chambers 40A and 40B are formed in a diametrically opposing positions in the elastic member 24 or on the radially outer side of the intermediate tubular member 229.

The intermediate tubular member 229 is provided with a pair of openings 41 passed in the radial direction at positions corresponding to the first liquid chambers 40A and 40B, respectively, and a protruding portion 242 protruding radially inward from the inner peripheral surface thereof and extending in the circumferential direction by an angle substantially smaller than 180 degrees. The circumferential ends of the protruding portion 242 adjoin the two openings 41, respectively. In the present embodiment, as shown in FIG. 11A, the protruding portion 242 has an upper surface which is flush with or forms a part of the upper end surface of the intermediate tubular member 229, and the lower surface of the protruding portion 242 is upwardly offset relative to the lower end surface of the intermediate tubular member 229.

As shown in FIG. 10, the protruding portion 242 has an arc shape (fan shape) in top view. As shown in FIG. 11A, the protruding portion 242 extends into the gap SC and is in contact with the outer peripheral surface of the inner yoke 25 at the inner peripheral surface thereof. The gap between the inner peripheral surface of the protruding portion 242 and the outer peripheral surface of the inner yoke 25 is thus filled and closed. Thus, as shown in FIGS. 10 and 11A, an arcuate circumferential passage 243 is defined by the outer surface of the inner yoke 25, the lower surface of the upper coil 226A, the upper surface of the lower coil 226B, the lower end surface of the upper outer yoke 27A, the upper end surface of the lower outer yoke 27B, the inner peripheral surface of the intermediate tubular member 229, and the circumferential end surfaces of the protruding portion 242. As shown in FIG. 10, the elastic member 24 is provided with a pair of connecting passages 44 that connect the first liquid chambers 40 to the corresponding openings 41, respectively. Thus, the first liquid chambers 40A and 40B are connected to each other via a communication passage 245 consisting of the connecting passages 44, the openings 41, and the circumferential passage 243. As shown in FIGS. 10 and 11A, the communication passage 245 passes through the gap SC between the upper coil 226A and the lower coil 226B.

Each of the first liquid chambers 40A and 40B, and the communication passage 245 is filled with the magnetic fluid 50 similarly as in the first embodiment. As shown in FIG. 11A, the upper coil 226A and the lower coil 226B are connected to a variable voltage source 260. The variable voltage source 260 applies a voltage to the upper coil 226A and the lower coil 226B, and generates a pair of magnetic fields directed in opposite directions and in the same magnitude. The variable voltage source 260 changes the magnitude of the output voltage based on a predetermined operation input or a control signal.

The mode of operation of the variable stiffness bushing assembly 212 configured as described above is described in the following. When a voltage is applied from the variable voltage source 260 to the upper coil 226A and the lower coil 226B, the upper coil 226A and the lower coil 226B generate magnetic fields that mutually oppose each other and in the same magnitude as indicated by arrowed lines in FIG. 11B. FIG. 11B shows magnetic field lines 270A due to the magnetic field generated by the upper coil 226A and magnetic field lines 270B due to the magnetic field generated by the lower coil 226B. As shown in FIG. 11B, the magnetic field lines 270A generated by the upper coil 226A and the magnetic field lines 270B generated by the lower coil 226B join each other in a part located between the upper coil 226A and the lower coil 226B. As a result, as indicated by the arrows in FIG. 10, the magnetic lines 270A and 270B extend in the radial direction with respect to the axial line X, and a magnetic field directed in the radial direction is applied to the communication passage 245. Due to this magnetic field, the viscosity of the magnetic fluid 50 flowing through the communication passage 245 increases, and the movement of the magnetic fluid 50 between the first liquid chamber 40A and 40B is impeded. As a result, the stiffness of the variable stiffness bushing assembly 212 is increased.

The features and advantages of the variable stiffness bushing assembly 212 configured as described above will be discussed in the following. The stiffness of the variable stiffness bushing assembly 212 can be changed by changing the voltage applied to the upper coil 226A and the lower coil 226B. In the present embodiment, the stiffness of the variable stiffness bushing assembly 212 is varied by applying a corresponding magnetic field to the communication passage 245 extending into the gap defined between the upper coil 226A and the lower coil 226B. Further, by generating a magnetic field in a direction opposing each other in the upper coil 226A and the lower coil 226B, the magnetic field lines are formed so as to jointly extend radially outward from the axial line X as shown in FIG. 10 so that the magnetic field can be applied to the communication passage 245 over a wide area ranging from the inner bore of the coil 226 to the communication passage 245 located radially outward thereof. Thereby, a magnetic field can be applied to the communication passage 245 over a wide area so that the viscosity of the magnetic fluid 50 can be varied in an efficient manner and over a wide range.

Furthermore, chain clusters of magnetic particles are formed in the magnetic fluid flowing through the communication passage 45 so as to extend radially outward along the magnetic field. Thereby, the movement of the magnetic fluid 50 in the circumferential passage 243 is impeded in an efficient manner, and the stiffness of the variable stiffness bushing assembly 212 can be varied over a wide range.

The present invention has been described in terms of specific embodiments, but the present invention is not limited by such embodiments and can be modified in various ways without departing from the scope of the present invention.

For instance, the communication passage 245 in the third embodiment was defined in the gap SC created between the upper coil 226A and the lower coil 226B and the gap SD defined between the upper outer yoke 27A and the lower outer yoke 27B, but may include only the gap SC or only the gap SD (or a passage extending on an outer periphery of the gap SC). Since the magnetic field lines are formed so as to extend radially outward as shown in FIG. 10, even when the communication passage 245 includes only gap SC or only the gap SD, an adequately strong magnetic field can be applied to the communication passage 245.

1. A variable stiffness bushing assembly, comprising:
an inner tubular member;
an outer tubular member coaxially surrounding the inner tubular member with an annular space defined between the inner tubular member and the outer tubular member; and
an elastic member connected between the inner tubular member and the outer tubular member;
wherein the inner tubular member includes a tubular inner yoke, a coil coaxially wound around the inner yoke, and a pair of outer yokes each attached to the inner yoke at an axially outer end thereof and opposing another outer yoke at an axially inner end thereof so as to define an annular gap therebetween, and
the elastic member internally defines a pair of first liquid chambers which are communicated with each other via a first communication passage provided by the annular gap defined between the outer yokes, the first liquid chambers and the first communication passage being filled with a magnetic fluid having a viscosity that changes in dependence on an intensity of a magnetic field applied thereto.

2. The variable stiffness bushing assembly according to claim 1, wherein the first liquid chambers diametrically oppose each other via a central axial line of the inner tubular member.

3. The variable stiffness bushing assembly according to claim 1, further comprising an intermediate tubular member made of material having a low magnetic permeability and surrounding the annular gap defined between the axially inner ends of the outer yokes, wherein the intermediate tubular member is provided with a protruding portion that blocks a part of the annular gap defined between the axially inner ends of the outer yokes, and a pair of openings passed radially therethrough in parts thereof adjoining respective circumferential ends of the protruding portion and communicating with the respective first liquid chambers.

4. The variable stiffness bushing assembly according to claim 3, wherein the axially inner end of one of the outer yokes is provided with a small diameter portion, and the intermediate tubular member abuts against an annular shoulder surface defined at a base end of the small diameter portion of the one of the outer yokes at a first axial end thereof, and against the axially inner end of another of the outer yokes at a second axial end thereof.

5. The variable stiffness bushing assembly according to claim 3, wherein the elastic member further defines a pair of second liquid chambers that circumferentially alternate with the first liquid chambers, and the intermediate tubular member further includes a central ring that partitions the annular gap into an axially separated two parts, and
wherein the first communication passage is defined by a part of the annular gap located on one side of the central ring, and a second communication passage communicating the second liquid chambers to each other is defined by a part of the annular gap located on another side of the central ring.

6. The variable stiffness bushing assembly according to claim 5, wherein the central ring is made of material having a high magnetic permeability.

7. The variable stiffness bushing assembly according to claim 5, wherein the axially inner end of each outer yoke is provided with a small diameter portion, and the intermediate tubular member includes a pair of cylindrical parts each abutting against an annular shoulder surface defined at a base end of the small diameter portion of a corresponding one of the outer yokes at a first axial end thereof, and against the central ring at a second axial end thereof.

8. The variable stiffness bushing assembly according to claim 7, wherein each cylindrical part is provided with a protruding portion that blocks a part of the annular gap defined between the corresponding outer yoke and the central ring, and a pair of openings passed radially therethrough in parts thereof adjoining respective circumferential ends of the protruding portion, the protruding portion of one of the cylindrical parts being offset from the protruding portion of the other cylindrical part by about 90 degrees as seen in an axial direction.

9. The variable stiffness bushing assembly according to claim 5, wherein the first liquid chambers oppose each other in a first direction which is orthogonal to a central axial line of the inner tubular member, and the second liquid chambers oppose each other in a second direction which is orthogonal to both the first direction and the central axial line.

10. The variable stiffness bushing assembly according to claim 3, wherein the coil includes a pair of coils that are axially aligned with each other, and the annular gap defined between the outer yokes extend into a gap defined between the two coils, the protruding portion of the intermediate tubular member extending into the gap between the two coils.

11. The variable stiffness bushing assembly according to claim 1, wherein the elastic member consists of a pair of cylindrical parts that axially abut against each other in a mutually aligned relationship, the first liquid chambers being formed by recesses which are recessed from a mutually opposing axial ends of the two cylindrical parts.

12. A variable stiffness bushing assembly, comprising:
an inner tubular member;
an outer tubular member coaxially surrounding the inner tubular member with an annular space defined between the inner tubular member and the outer tubular member; and
an elastic member connected between the inner tubular member and the outer tubular member;
wherein the inner tubular member includes a tubular yoke, a pair of coils coaxially wound around the yoke and axially aligned with each other to define a gap therebetween, the pair of coils being configured to generate magnetic fields directed in opposite directions,
the elastic member internally defines a pair of liquid chambers which are communicated with each other via a communication passage provided by the gap defined between the pair of coils, the pair of liquid chambers and the communication passage being filled with a magnetic fluid having a viscosity that changes in dependence on an intensity of a magnetic field applied thereto.

13. The variable stiffness bushing assembly according to claim 12, further comprising an intermediate tubular member made of material having a low magnetic permeability and surrounding the gap defined between the pair of coils, wherein the intermediate tubular member is provided with a protruding portion that blocks a part of the gap defined between the pair of coils, and a pair of openings passed radially therethrough in parts thereof adjoining respective circumferential ends of the protruding portion and communicating with the respective liquid chambers.
